(19) United States
(12) Patent Application Publication
(10) Pub. No.: US 2007/0061889 A1
(43) Pub. Date: Mar. 15, 2007

(54) SYSTEM AND METHOD FOR CONTROLLING DISTRIBUTION OF ELECTRONIC INFORMATION

(75) Inventor: Narayan Sainaney, Vancouver (CA)

Correspondence Address: GOWLING LAFLEUR HENDERSON LLP (OTT), SUITE 2600, 160 ELGIN STREET, OTTAWA, ON, K1P1C3, CA

(73) Assignee: Sand Box Technologies Inc., Vancouver (CA)

(21) Appl. No.: 11/531,137

(22) Filed: Sep. 12, 2006

Related U.S. Application Data
(60) Provisional application No. 60/715,571, filed on Sep. 12, 2005.

(51) Int. Cl. H04N 7/16; H04L 9/32; H04L 9/00; G06F 17/30; H04K 1/00; G06F 7/04; G06K 9/00; H03M 1/68

(52) U.S. Cl. 726/26; 713/165; 713/167; 726/27; 713/183

(57) ABSTRACT

A method for managing access to electronic documents, wherein the documents include code scripts executable by, the documents being viewable by recipients only when viewed in a the document viewer upon satisfaction of an access policy embedded in the document, the method comprising the steps of opening the document for viewing in the document viewer by the recipient; executing the code to obscure viewing of selected pages of a the document upon the document being opened; communicating with an authentication server, by the viewer, for authenticating the recipient upon the recipient attempting to read the document; and unobscuring the selected pages by the viewer upon receipt of the recipient authentication.

### CROSS REFERENCE TO RELATED APPLICATIONS

This application claims the benefit of U.S. Provisional patent application Ser. No. 60/715,571 filed Sep. 12, 2005, the disclosure of which is incorporated herein by reference.

### BACKGROUND OF THE INVENTION

The present invention relates to a system and method for managing and controlling access to electronic information and electronic documents so that only authorized users may open protected information and documents.

The portable document format (PDF) is used extensively for the publication of digital documents. An advantage of this format is that the documents they cannot be readily modified. Documents prepared in the PDF format can be viewed and printed by users in a consistent format without regard or need for the software that created the PDF document. The documents can be digitally signed or password-protected by using an authoring tool such as Adobe Acrobat.

Several software tools have been developed to work with PDF documents such as Adobe Acrobat™ reader by Adobe Systems which is freely distributed and is typically installed on computers used in both corporate and personal environments, and is used for viewing PDF documents.

Businesses in many industries publish PDF documents on their websites, or provide them directly to recipients. Once a PDF document has been released to a recipient, the publisher has limited control over how the document is used, who can access it, or when it can be accessed. Furthermore, the publisher does not have the ability to manage individual recipients or obtain intelligence on how the document is used.

Password protection is limited in some situations, as it does not prevent unauthorized sharing of the document, as the recipient can easily share the password with others.

A need still exists for improved systems and methods for providing access to information by authorized users and which prevent unauthorized users from gaining access to the information.

Accordingly, there is a need for a system and method that mitigates at least some of the above.

### SUMMARY OF THE INVENTION

The present invention seeks to provide a system and method that allows an authoring user or other controlling party to maintain access control over electronic information.

Furthermore, the present invention seeks to provide a method for conveniently adding security features to electronic documents so that the publisher has control over who can access the document. Furthermore, the method provides for publishers to gather useful information about the recipients or readers of their documents.

In a preferred embodiment these security features include locking of the content of the document until the reader provides satisfactory authentication to the publisher. Locking can include obscuring the content of the document; or encrypting the content of a document so that the document viewer will not reproduce the content (such as for display or printing), until the recipient provides satisfactory authentication. The authentication may include a two-factor authentication, such as the use of a hardware or software token in conjunction with user identification.

The authorization may also be for a limited period of time, or completely revoked by the publisher.

A further aspect of the invention is a method to obscure the content of the document until the reader provides personal contact information. Such information may for example, be forwarded to a customer relationship management system for use in marketing activities.

In accordance with this invention there is provided a document distribution system comprising:

a. one or more locked documents for distribution to one or more recipients, the documents being viewable by the recipients only when viewed in a document viewer and upon satisfaction of a security policy embedded in the locked document;

b. a network connected server for authenticating the recipient of the document upon the recipient attempting to read the document; and

c. a protocol for unlocking the document upon the server authenticating the recipient.

In accordance with another embodiment of the present invention there is provided a method for managing access to electronic documents, wherein the documents include code scripts executable by, the documents being viewable by recipients only when viewed in a the document viewer upon satisfaction of an access policy embedded in the document, the method comprising the steps of:

a. opening the document in the document viewer by the recipient;

b. executing the code to obscure viewing of selected pages of a the document upon the document being opened;

c. communicating with an authentication server, by the viewer, for authenticating the recipient upon the recipient attempting to read the document; and

d. unobscuring the selected pages by the viewer upon receipt of the recipient authentication.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a block diagram of the major components of an electronic information distribution system according to an embodiment of the invention;

FIG. 2 is a block diagram of the server architecture according to an embodiment of the present invention;

FIG. 3 is a diagram showing a logical view of the server of FIG. 2;

FIG. 4 is flow chart showing an encoding process according to an embodiment of the present invention;

FIG. 5 is a flow chart of an authentication process according to an embodiment of the invention;

FIG. 6 is a flow chart of a document viewing process according to an embodiment of the invention;

FIG. 7 is a ladder diagram showing the authentication process; and

FIG. 8 is a ladder diagram of an authentication process in a CRM application according to an embodiment of the present invention.

### DETAILED DESCRIPTION OF THE PREFERRED EMBODIMENTS

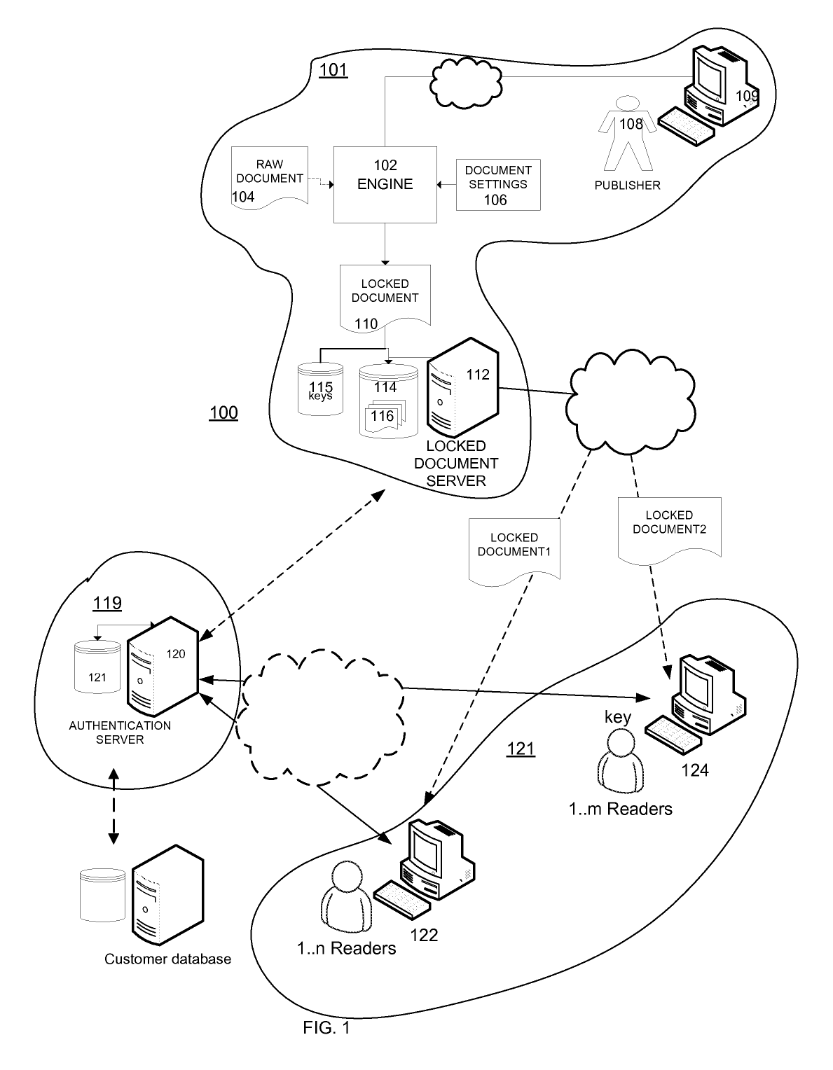

Referring back to FIG. 1, there is shown the general components of a electronic information distribution system 100 according to an embodiment of the present invention. The system 100 of the preferred embodiment is described in terms of a document distribution system can be broken down conceptually into three functional components: an authoring component 101, a viewing component 121 and an authentication server 119.

For convenience, the embodiments described herein are described with respect to a document in the Portable Document Format (PDF) which is a file format developed by Adobe Systems for presentation of documents independent of the original application software, hardware, and operating system used to create those documents. A PDF file can describe documents containing any combination of text, graphics, and images in a device independent and resolution independent format. These documents can vary in length and complexity with a rich use of fonts, graphics, colour, and images. In addition to encapsulating text and graphics, PDF files are most appropriate for encoding the exact look of a document in a device-independent way. In contrast, markup languages such as HTML defer many display decisions to a rendering device such as a browser, and will not look the same on different computers.

Free document viewers for many platforms are available. At creation time the author may inlude code or scripts within the document executable by the the document viewer. These codes and scripts may for example, restrict viewing, editing, printing or saving. It is assumed that PDF files are capable of being created with embedded codes or scripts, that in turn can be executed or read by the document viewer and that the recipient is not able to aceess or change these scripts or codes unless authorised to do so.

The authoring component 101 includes a document creation engine 102 for creating protected documents 116 by embedding an access policy script executable by the document viewer; a web interface (not shown) for a publisher 108 to access the engine 102 via his or her computer 109; and a network connected server 112 for running the engine 102 and accessing a database 114 that stores the protected documents 116. The engine 102 interfaces with the file I/O of the server to input a clear document 104 and combine it with publisher specified document settings 106 to create the protected document 110 in a manner to be described below. The authoring component 101 allows the authoring user 108 to establish access policies that block certain functions normally accessible by the viewing user(recipients) 124, 122. For example, the author/publisher 108 may deny a viewing user privileges such as printing and copying of the clear text. The authorizing component may also establish access policies based on time or location, e.g., the document 116 may only be accessed during a certain time interval on certain computers.

The protected documents are locked for viewing but are made available to users via email, the Internet or as appropriate for a particular distribution system. In the present context, the term locked would mean any instance where the recipients rights to the document would be restricted, such as preferably, viewing or printing or copying and saving to disk. The preferred form of locking is to obscure or encrypt the content as will be described later. The authoring component 101 also includes a key repository 115 for storing encryption keys when documents are encrypted. The protected documents 116 are made available to the readers computers 122, 124 by various conventional means, including by Internet e-mail, on electronic media such as a CD-ROM, or by placing the documents on a public Internet site, available for download.

The authentication component includes an authentication server 120 and user identity database 121 for maintaining a list of users or readers 122, 124 that have or will be granted access to particular protected documents 116 by the publisher 108. The authentication component is capable of coordinating exchange of information with the various document readers 121 in order to unlock the protected documents as will be described later.

The viewing component 121 includes a number of recipients 122, 124 running a document viewer program that interacts with the documents to allow unlocking of the locked document 110. The document viewer program in addition is capable of communicating with the authentication component 119 to access the authentication server in order to unlock the document. In a preferred embodiment, the locked documents are PDF documents and the document viewer is the Adobe Acrobat reader.

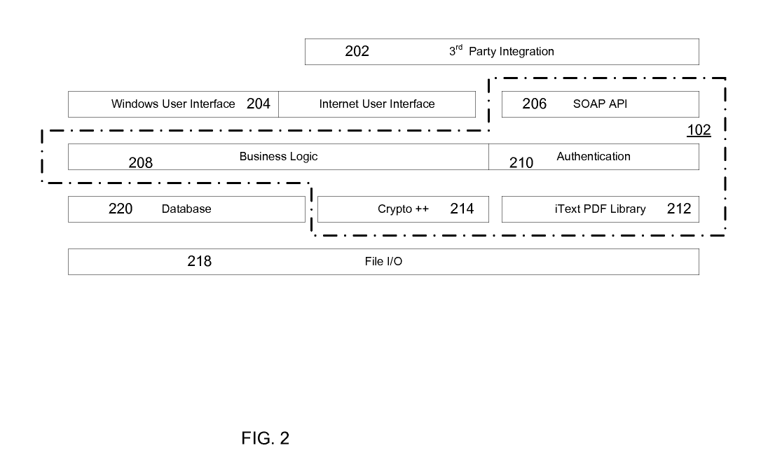

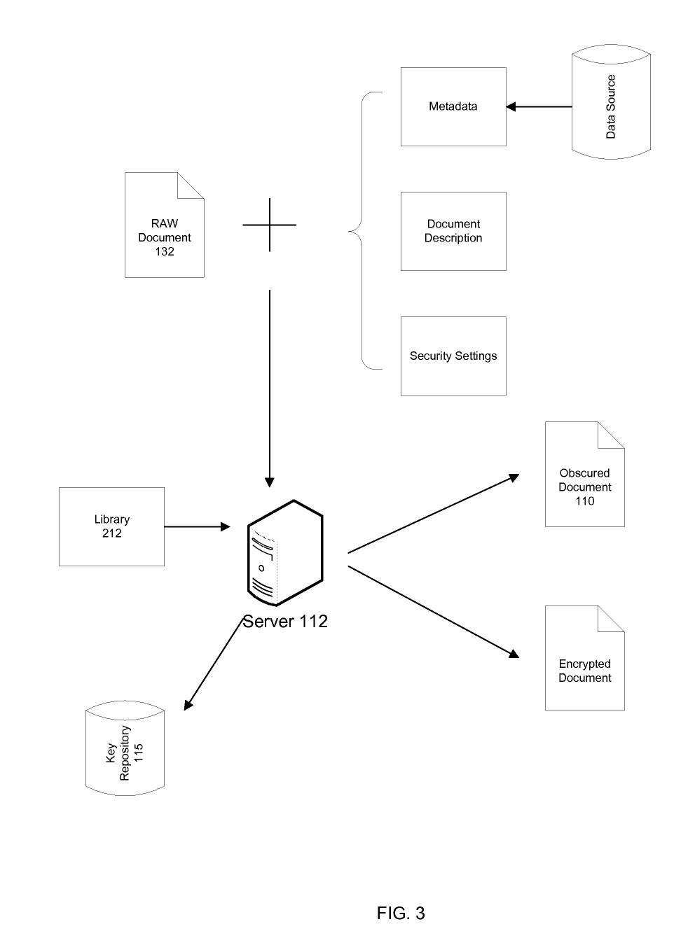

Referring to FIG. 2, the server 112 architecture is shown in more detail. The server comprises a 3^{rd} party integration module 202, such as for example a CRM system; a windows and/or Internet user interface 204, the engine 102 which includes a SOAP API 206, business logic 208, an authentication module 210 (which could be implemented on a separate authentication server as shown in FIG. 1) an iText PDF library 212 and a cryptography module 214. The iText PDF library is a library that allows users to generate PDF files on the fly; its API's and documentation are incorporated herein by reference and is available through open source. The server 112 also includes a database layer 220 for accessing data such as: document metadata; document description, document security settings and providing access to the key repository 115. A file I/O layer 218 implements the file input and output routines for reading clear text files and writing the protected files 110 to storage. A logical arrangement of these layers as they relate to the physical components that interact with the server is shown schematically in FIG. 3.

The manner of using the system 100 to create a locked document will now be described below.

The publisher 108 of a document begins with a raw file 104 containing data from a database or other data source of their choosing. Document descriptors (title, subtitle, abstract, author, author's signature, etc.) are applied as desired.

The publisher 108 also determines the security settings. Specifically, these include printing rights; a choice of obscured or encrypted, a pre-determined expiry date, an offline time limit, and the preferred encryption algorithm.

The server 112 avails itself of the library (such as the iText PDF library available through open source), to modify the raw file 104 and generate one of a series of outputs dependent on the settings chosen by the publisher.

Four possible outputs exist, as per the security settings selected by the publisher. Specifically, the outputs are documents that can be either obscured or encrypted. Two options exist for obscured documents: password protected or requiring personal contact information. Two options exist for encrypted documents: password protected or password and two-factor hardware authentication protected.

In a preferred embodiment obscured locked documents are created to include a new cover page having password or personal contact information fields and subsequent pages are obscured from view until unlocked by the document viewer. Obscuring may be achieved by placing and sizing button type control to cover each of the content pages to be obscured. The engine 102 also embeds a program code or script with the created document which is later executed by the document viewer to communicate with the authentication server 120 during authentication of the user and unlocking of the document.

If the encrypted option is chosen, the engine 102 generates a key, which is stored in the key repository 115 for future use in the decrypting process. The publisher has the option of choosing from a variety of well-known encryption algorithms. The documents remain unavailable to a recipient until decoded (see below).

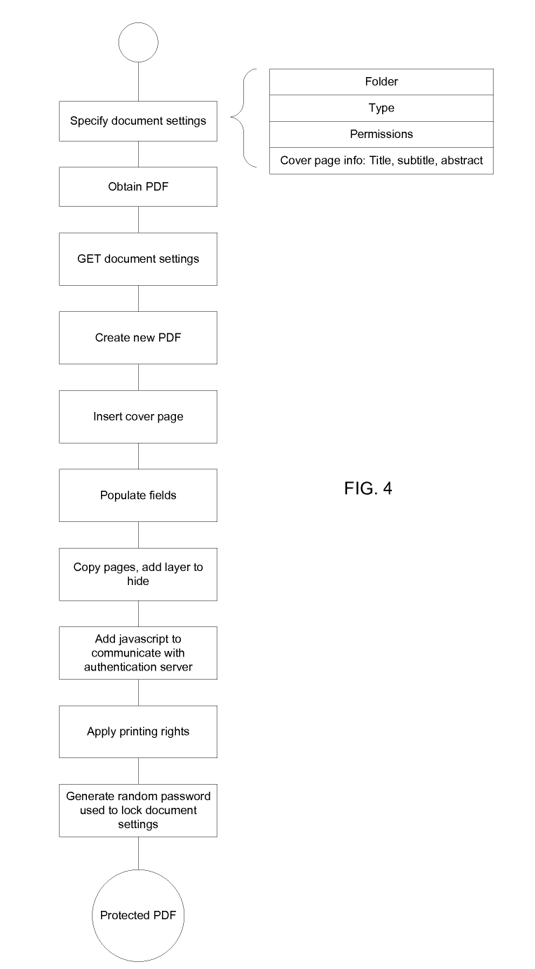

Referring to FIG. 4 there is shown the steps of creating a PDF format protected document are, as mentioned earlier the publisher 108 uses a 3^{rd} party application to create a PDF document or has access to a PDF document. The publisher interacts with the protected PDF engine 102 through a web interface or a windows application on his computer 109. From within the interface, the publisher selects a storage location or folder where a new protected PDF document will be created. The publisher specifies the desired permissions for the file such as i. offline access (days)—this is the maximum number of consecutive days the cookie on the readers computer is valid. The cookie allows the reader to open the document without having to authenticate. A cookie is only created when a reader is authenticated. Zero days means the reader always has to authenticate. (−1) days means the reader has unlimited offline access to the file; ii printing options such as Not Allowed, Low Resolution, High Resolution Pages that are to remain unprotected (as a free sample etc). These are either Comma separated (e.g. 1,3,4,7) Ranged (e.g. 1-7) Mixed (1,3,4,6-10). The user enters information for the cover page information for the document which includes (but is not limited to) a Title; a Subtitle and Abstract. The following information may also be included:
i. Cover Page Template
ii. Version (e.g. 1.0.0 or 10.2.0)
iii. Status (Inactive, Active or Retired)
iv. PDF file to be converted to protected PDF

Once all the information in entered, the publisher instructs the engine 102 to process the PDF document with the document settings as specified above. The server 112 downloads the PDF document 104 and creates a new PDF file and inserts the cover page as specified above. The document information provided is populated into fields on the cover page. The server 112 copies each page from the original PDF document 104 into the new PDF document 110. For each page, the server adds a layer hiding the contents of the page where the page is NOT specified as being excluded. The server adds a (JavaScript) code to the new PDF document. The server applies the printing rights to the PDF document (which will be honored by PDF readers such as Acrobat Reader) and generates a random password and assigns this as the owner password (so the document settings cannot be changed). The creation of the protected PDF document is thus complete.

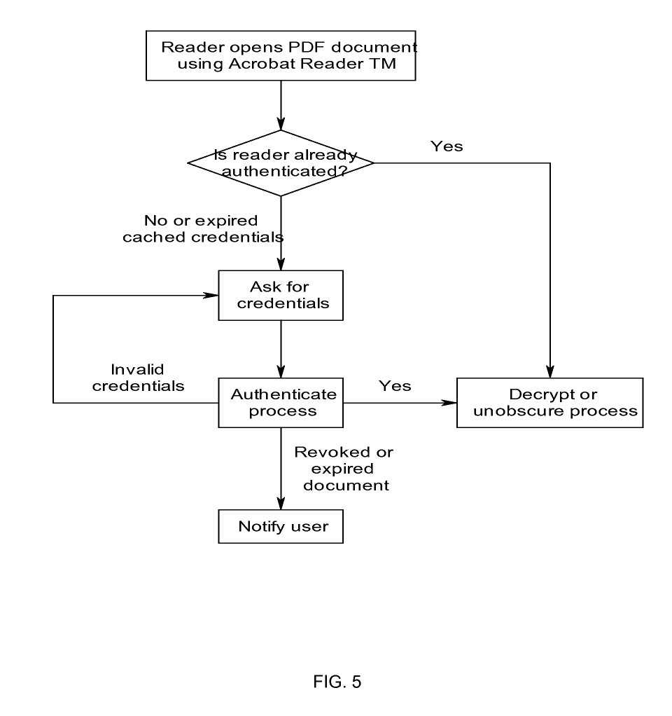

Referring now to FIG. 5 there is shown a flow chart of the decoding process. Decoding is required when a reader wishes to open a protected document that has been either obscured or encrypted as described above. It is assumed that the user has a suitable reader installed on his or her computer and that the reader's computer has access to the authentication server 119 or server 112.

Generally the process begins with the authentication of the user, caused by the execution of the code stored in the protected document. If the reader's credentials have already been authenticated, the decoding process can proceed directly to the decryption or the un-obscure procedure (see below).

If the reader's credentials have not been authenticated, or if authentication has expired, then the process proceeds to the authentication procedure. Authentication has several possible outputs as described below.

When authentication is required, the reader is requested to supply credentials. Credentials can consist of username and password alone, or can include a hardware key or ID if required, or can consist of personal contact information such as name, company, job title, address, telephone number, and email address.

When supplying credentials, which may include a user password, only the reader's username is transmitted to the authentication server. The server responds with a challenge in the form of a randomly generated number. The code embedded in the document performs a hash such as the Secure Hash Algorithm 1 (SHA-1) on the random number and the reader's password, responding to the server with a hash. The username, random number and hash are transmitted to the data source 114, where SHA-1 hash is again performed on the random number and the password as held by the data source. The data source can respond with one of four outputs; ‘Yes’, ‘No’, ‘Revoked’, or ‘Expired’. If the server receives a ‘Yes’ response, it in turn authorizes the reader's software to unobscure the PDF document (see decrypt/unobscure procedure later). A ‘No’, ‘Revoked’, or ‘Expired’ response will generate an appropriate message to be delivered to the reader, and a ‘No’ response will also request the reader to resubmit their credentials.

All transmissions between the reader, the authentication server and the data source are made over the Internet, either using secure hypertext transmission protocol (HTTPS) commands POST, GET, or simple object access protocol (SOAP) as defined by the configuration.

Throughout the authentication process, the reader's password is never transmitted over the Internet, nor ever shared with the server.

In the event that the publisher has specified that encryption must be used for security, then a Yes response from the server will include the transmission of a key to the reader.

In the event that the publisher has specified that the reader must supply personal contact information, on receipt of this information by the server, it is forwarded to the customer database used by the data source. Simultaneously, authorization to unobscure the document is returned to the document viewer. The document viewer continues to record the number of pages read, and the time spent reading them, and has the ability to transfer this information back to the server. Data obtained in the process become available to be manipulated and shared with data source providers.

Optionally, the publisher 108b may specify that the reader's contact information needs to be verified prior to un-obscuring the document. In this case, information to unobscure the document is transmitted to an email address supplied by the reader.

The decryption and un-obscuring process may be described generally as follows:

Once a reader's credentials have been authenticated, the document can be either un-obscured or decrypted, as appropriate. To un-obscure a document, the obscuring elements are simply hidden by the document viewer. To decrypt an encrypted document, a key is used to process the file in memory. The process is not recorded or persisted in any manner.

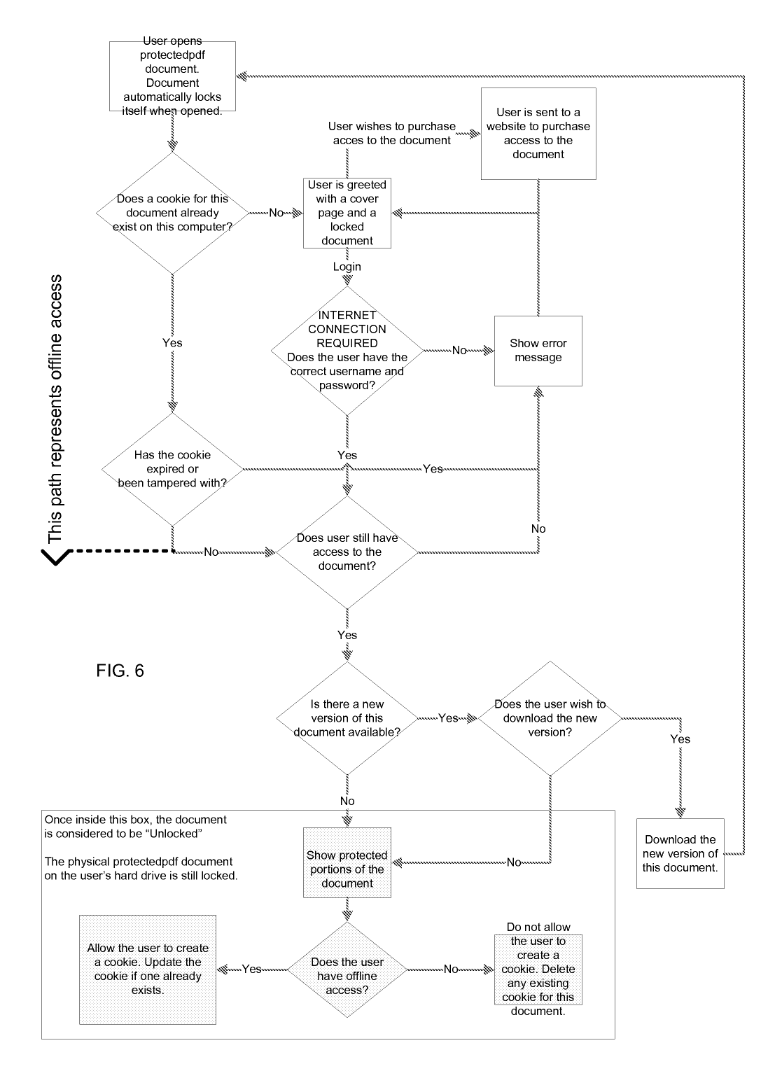

The process of unlocking a protected PDF document (using Adobe Acrobat Reader) will now be described in detail with reference to FIG. 6.
1. The user opens the protected PDF document and the document viewer executes the embedded JavaScript code that ensures that the obscuring layers are visible (i.e. hiding the contents)
2. The document viewer checks for an authentication cookie to see if the user has already been granted access to the document. If the cookie exists, the document viewer checks to ensure that the cookie has not expired. If the cookie is still valid, the document unlocks. (see step 13 below)
3. The user is greeted with the cover page and fills in their credentials. Credentials can be:
   a. Email address/password
   b. Username/password
   c. User ID/PIN
   d. Etc (as desired by the client)
4. The JavaScript code embedded in the document sends the user identifier (email address, username etc) to the server 112 or authentication server 120 using one of the following protocols:
   a. HTTP
   b. HTTPS
   c. SOAP
5. The server 120 checks the user identifier against the identity database 121. The server generates a cryptographically strong random number (using the Microsoft crypto API) and sends the number to the protected PDF document.
6. The protected PDF document takes the random number and generates a hash using a strong hash algorithm such as MD4, MD5, SHA1 or SHA256 with the user's password as the key.
7. The protected PDF document sends the hash to the server 112.
8. The server 112 sends the user identifier, the random number and the hash code to the authentication authority.
9. The authentication authority computes a server side hash on the random number using the user's password as the key.
10. If the server side hash matches the hash computed by the protected PDF document, the user knew the correct password. The authentication authority transmits success or failure to the server 112.
11. If the authentication server reports an unsuccessful hash match, the user receives an error message.
12. If the authentication server 120 reports a successful hash match, the server 112:
   a. Checks to see if the user has been granted access to the document.
   b. Checks to see if the document is still active (and has not been retired)
   c. Checks to see if a newer version of the document exists.
   d. If all the conditions above pass, the server delivers JavaScript code for the protected PDF document Reader to hide the layer obscuring the contents of the file.
   e. If there is a new version but the current version has not been retired, the user is notified of the new version but is allowed to read the document.
   f. An authentication cookie is created specific to this document and the cookie's timestamp is updated.
13. Regardless of the outcome, the server logs the authentication/attempted authentication for auditing.

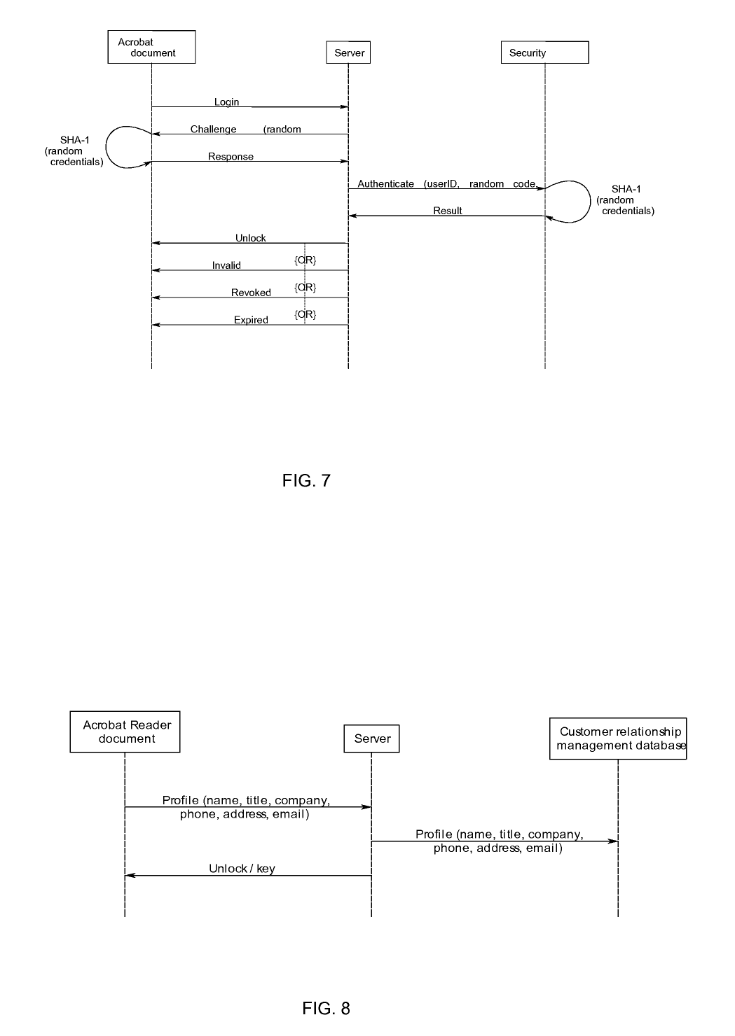

The authentication process is shown in more detail in FIG. 7.

The process for unlocking a protected-PDF document (using Adobe Acrobat Reader) for CRM purposes is described below.
1. The user opens the protected PDF document and the document ensures that the obscuring layers are visible (i.e. hiding the contents)
2. The document checks for an authentication cookie to see if the user has already been granted access to the document. If the cookie exists, the document checks to ensure that the cookie has not expired. If the cookie is still valid, the document unlocks.
3. The user fills in their contact information and any other survey questions such as Name, Title, Company, Email, Number of employees etc.
4. The JavaScript code embedded in the document sends the form data to the server 112.
5. The server adds the data to a database and notifies any 3^{rd} party integration about the lead once it:
   a. Checks to see if the document is still active (and has not been retired)
   b. Checks to see if a newer version of the document exists.
   c. If all the conditions above pass, the server delivers JavaScript code for the protected PDF document to hide the layer obscuring the contents of the file.
   d. If there is a new version but the current version has not been retired, the user is notified of the new version but is allowed to read the document.
   e. An authentication cookie is created specific to this document and the cookie's timestamp is updated.
      Regardless of the outcome, the server logs the authentication/attempted authentication for auditing.
      The process for creating an encrypted document according to an embodiment of the present invention is described below.
1. The publisher/author uses a 3^{rd} party application to create a PDF document.
2. Interacts with the engine 102 through a web interface (such as protectedPDF.com) or a windows application
3. From within the interface, the publisher selects a folder where the new document will be created.
4. The publisher specifies a document type
5. The publisher specifies pages that are to remain unencrypted (free sample etc). These are either
   v. Comma separated (e.g. 1,3,4,7)
   vi. Ranged (e.g. 1-7)
   vii. Mixed (1,3,4,6-10)
6. The following information could for example be included::
   a. Version (e.g. 1.0.0 or 10.2.0)
   b. Status (Inactive, Active or Retired)
   c. PDF file to be converted to protected PDF
7. The publisher submits all the information.
8. The server 112 downloads the selected PDF file 104.
9. The server 112 generates a cryptographically strong random number (key)
10. The server 112 creates a new PDF file and copies each page from the original PDF file into the new PDF file. For each page, the server finds the data stream that represents the Postscript describing the contents of that page. The server encrypts the contents of the page using an encryption algorithm such as AES or 3DES with the key generated (where the page is NOT specified in step 5)
11. The server specifies that the stream can be decrypted with a plugin that can be downloaded to run in the Reader(document viewer).
12. The creation of the protected PDF file is complete.
   The process for unlocking the encrypted document (using Adobe Acrobat Reader as a document viewer) is described below.
1. The user opens the protected PDF document and Adobe Acrobat recognizes that the a decryption plug-in is required.
2. The document checks for a decryption key on the user's local machine. If a key is found, the document is unencrypted and an access log is sent to the protected PDF server. Otherwise:
3. A dialog box asks the user to fill in their credentials. Credentials can be:
   a. Email address/password
   b. Username/password
   c. User ID/PIN
   d. Etc (as desired by the client)
4. The plug-in sends the user identifier (email address, username etc) to the protected PDF server using one of the following protocols:
   e. HTTP
   f. HTTPS
   g. SOAP
5. The server checks the user identifier against the identity database.
6. The server generates a cryptographically strong random number (using the Microsoft crypto API) and sends the number to the protected PDF file.
7. The plug-in takes the random number and generates a hash using a strong hash algorithm such as MD4, MD5, SHA1 or SHA256 with the user's password as the key.
8. The plug-in sends the hash to the server.
9. The server 112 sends the user identifier, the random number and the hash code to the authentication authority.
10. The authentication authority computes a server side hash on the random number using the user's password as the key.
11. If the server side hash matches the hash computed by the protected PDF document, the user knew the correct password. The authentication authority transmits success or failure to the server.
12. If the authentication server reports an unsuccessful hash match, the user receives an error message.
13. If the authentication server reports a successful hash match, the protected PDF server:
   h. Checks to see if the user has been granted access to the document.
   i. Checks to see if the document is still active (and has not been retired)
   j. Checks to see if a newer version of the document exists.
   k. If all the conditions above pass, the server delivers the decryption key and the current policy for the document (eg. printing allowed etc) to the plug-in.
   l. The plug-in decrypts the pages as needed and enables the printing menu if allowed.
   m. If there is a new version but the current version has not been retired, the user is notified of the new version but is allowed to read the document.
   n. The decryption key is encrypted and stored on the user's local machine if the user has offline access.
14. Regardless of the outcome, the server logs the authentication/attempted authentication for auditing.

As will be apparent protecting a document in the manner of the present invention has applications in many fields. For example, financial institutions can securely collect personal information from clients via their website for purposes such as credit card applications. However, they lack the means to return this information to clients in a secure manner. As many credit card applications are missing pertinent data or perhaps are for the wrong product altogether, the financial institution can only decline the application or follow-up by telephone or letter mail. Both options frustrate their potential client and lead to lost sales. Using the protected PDF document as a means of delivering information to the client gives the client the opportunity to review their information on file, correct it as required, or discuss with the financial institutions personnel while both are looking at the same information.

A company can use protected PDF documents to secure company trade secrets. These can be made available to all relevant employees of the company who can access the information remotely from any computer connected to the Internet. However, should that employee leave the company, all access to the documents can be prevented, leaving valuable information secure.

In a related example, the company can also use protected PDF documents for company policies and procedures. Using the techniques described, the company can ensure that employees are always consulting the most current version of the policy, and that all employees do in fact read the policies.

A direct link to a publisher's CRM is a powerful application of this process. Exemplary uses include a financial institution marketing a new product to existing clients and being able to determine exactly who looked at the document, whether it was read in depth or not, and if it was shared with friends or family; or a consumer goods retailer placing a white paper on their website, collecting contact information for individuals reading the white paper, and then being able to contact them electronically or in person to promote relevant products.

As will be apparent to those skilled in the art in light of the foregoing disclosure, many alterations and modifications are possible in the practice of this invention without departing from the spirit or scope thereof. The system 100 may be configured differently by combining or splitting functions performed by the various servers, varying connections etc.

What is claimed is:

1. A document distribution system comprising:
a. one or more locked documents for distribution to one or more recipients, the documents being viewable by the recipients only when viewed in a document viewer and upon satisfaction of a security policy embedded in said locked document;
b. a network connected server for authenticating the recipient of the document upon the recipient attempting to read the document; and
c. a protocol for unlocking the document upon said server authenticating said recipient.

2. A system as defined in claim 2, wherein said protocol includes input of a password by said user and wherein said user password is not transmitted over network during said authentication, nor shared with said server.

3. A system as defined in claim 1, said document being a PDF file.

4. A method for managing access to electronic documents, wherein said documents include code scripts executable by, the documents being viewable by recipients only when viewed in a said document viewer upon satisfaction of an access policy embedded in said document, the method comprising the steps of:
a. opening said document for viewing in said document viewer by said recipient;
b. executing said code to obscure viewing of selected pages of a said document upon said document being opened;
c. communicating with an authentication server, by said viewer, for authenticating the recipient upon the recipient attempting to read the document; and
d. unobscuring said selected pages by said viewer upon receipt of said recipient authentication.

5. A method as defined in claim 4, including setting a cookie for said document on said recipient's computer.

6. A method as defined in claim 4, including displaying cover page for input of recipient information upon said recipient opening said document in said viewer.

7. A method as defined in claim 4, including upon said recipient being verified, determining whether a new version of said document is available on said server.

8. A method as defined in claim 7, including prompting said recipient for download of said new version.

9. A customer relationship management system comprising:
a. a customer information database;
b. one or more locked documents distributed to one or more users;
c. a network connected server for receiving information relating to a user of the document upon the user attempting to read the document and for unlocking the document upon receipt of this information, said server forwarding said received information to said customer information database.

10. A method for creating a one or more locked documents for distribution to one or more recipients, the documents being viewable by the recipients only when viewed in a document viewer and upon satisfaction of an access policy embedded in said locked document, said method comprising:
a. preventing viewing of said selected pages, by inserting code in said document, said code for defining an access policy for selected pages of a said document; and
c. publishing said document.
